(19) United States
(12) Patent Application Publication
(10) Pub. No.: US 2015/0261519 A1
(43) Pub. Date: Sep. 17, 2015

(54) METHOD AND SYSTEM OF SOFTWARE UPDATE AND MOBILE DEVICE

(71) Applicant: Quanta Computer Inc., Kuei Shan Hsiang (TW)

(72) Inventors: Ta-Jen Hsieh, Kuei Shan Hsiang (TW); Sheng-Pin Chuang, Kuei Shan Hsiang (TW)

(21) Appl. No.: 14/321,996

(22) Filed: Jul. 2, 2014

(30) Foreign Application Priority Data
Mar. 17, 2014 (TW) 103109866

(51) Int. Cl. G06F 9/445; G06F 21/64; H04L 29/08; H04L 29/06

(52) U.S. Cl. CPC G06F 8/65; H04L 63/0428; G06F 21/64; H04L 67/10

(57) ABSTRACT

A software update method is provided. The software update includes encrypting and compressing an original package to obtain a publication package, transmitting the publication package from a service server to a mobile device according to a download request from the mobile device, checking whether the configuration of the mobile device meets requirements or not, and decompressing the publication package if the configuration of the mobile device meets the requirements.

### CROSS REFERENCE TO RELATED APPLICATION

The present application is based on, and claims priority from, Taiwan (International) Application Serial Number 103109866, filed Mar. 17, 2014, the invention of which is hereby incorporated by reference herein in its entirety.

### TECHNICAL FIELD

The technical field relates to a software update method, and more particularly to a software update method for providing security protection and a download checking mechanism.

### BACKGROUND

Over-the-Air (OTA) updating is used to upgrade software in mobile devices such as smartphones, tablet computers and the like. OTA includes software updates, firmware updates, and device management. This update method allows users to download new software version via the phone network or Wi-Fi network and is widely used in mobile devices using the Android operating system. Therefore, in order to ensure that the mobile device can successfully complete an update during OTA, the present invention provides a corresponding security protection method and the download checking mechanism thereof.

### SUMMARY

An embodiment of the present invention provides a software update method. The software update method includes the steps of: encrypting and compressing an original package to obtain a publication package; transmitting the publication package from a service server to a mobile device according to a download request from the mobile device; checking whether the configuration of the mobile device meets the requirements or not; and decompressing the publication package if the configuration of the mobile device meets the requirements.

An embodiment of the present invention provides a software update system. The software update system includes a service server and a mobile device. The service server includes a first processing unit and a communication unit. The first processing unit encrypts and compresses an original package to obtain a publication package. The communication unit transmits the publication package from a service server to a mobile device according to a download request from the mobile device. The mobile device includes a receiving unit and a second processing unit. The receiving unit receives the publication package. The second processing unit checks whether the configuration of the mobile device meets the requirements or not and decompresses the publication package if the configuration of the mobile device meets the requirements.

An embodiment of the present invention provides a mobile device. The mobile device includes a receiving unit and a processing unit. The receiving unit receives, from a service server, a publication package which has been encrypted and compressed. The processing unit checks whether the configuration of the mobile device meets the requirements or not and decompresses the publication package if the configuration of the mobile device meets the requirements.

### BRIEF DESCRIPTION OF THE DRAWINGS

The present invention can be more fully understood by reading the subsequent detailed description and examples with references made to the accompanying drawings, wherein:

FIG. 1 is a block diagram showing a software update system 10 according to an embodiment of the present invention.

FIG. 2 is a block diagram of a mobile device 20 according to an embodiment of the present invention.

FIG. 3 shows a flow diagram to illustrate a software update method according to an embodiment of the present invention.

FIG. 4 shows a flow diagram to illustrate the procedure by which the second processing unit 112 checks the configuration of a mobile device according to an embodiment of the present invention.

### DETAILED DESCRIPTION

The following description is of the best-contemplated mode of carrying out the present invention. This description is made for the purpose of illustrating the general principles of the present invention and should not be taken in a limiting sense. The scope of the present invention is best determined by reference to the appended claims

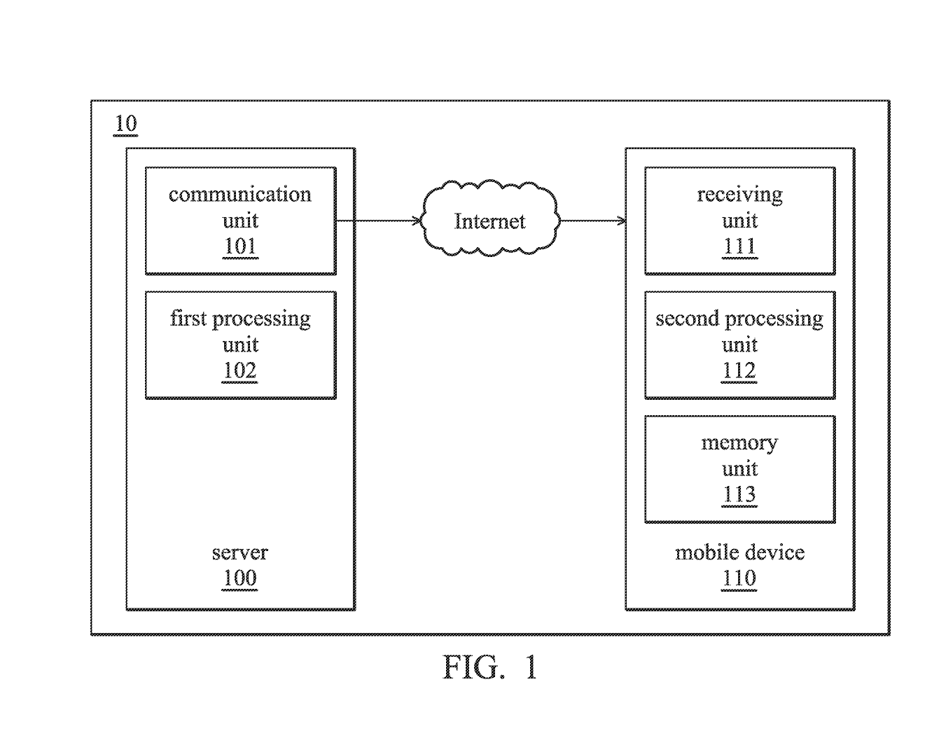

As an embodiment shown in FIG. 1, the software update system 10 of the present invention includes a server 100 and a mobile device 110, but the present invention is not limited thereto. In this embodiment, the server 100 includes a communication unit 101 and a first processing unit 102. The mobile device 110 includes a receiving unit 111, a second processing unit 112 and a memory unit 113.

The first processing unit 102 of the server 100 encrypts and compresses an original package to obtain a publication package. In this case the original package is used to update the operation system loaded in the mobile device 110. For example, the original package is the software package used to update the Android operation system, but the present invention is not limited thereto. After the communication unit 101 receives the download request coming from the mobile device 110 through the Internet, the communication unit 101 transmits the publication package to the mobile device 110. Alternatively, the communication unit 101 transmits a new publication package to the specified mobile device 110 when the supplier of the mobile device 110 releases the new publication package. In this case, the Internet represents the mobile wireless network of the Wi-Fi wireless network and the mobile device 110 represents a smartphone which is equipped with the Android operation system, but the present invention is not limited thereto. The receiving unit 111 receives the publication package. Finally, the second processing unit 112 checks whether the configuration of the mobile device meets the requirements (i.e. particular specifications or operational conditions) or not. Then the second processing unit 112 decompresses the publication package if the configuration of the mobile device 110 meets the requirements.

In this embodiment, the first processing unit 102 prepares a first key to encrypt the original package, wherein the encryption method applies the symmetric encryption of Open SSL (Secure Sockets Layer protocol), but the present invention is not limited thereto. Then the first processing unit 102 calculates a check sum according to the encrypted original package. The check sum is an MD5 value which is calculated through the Message-digest Algorithm 5 (MD5) according to the files contained in the original package. It is notable that the Message-digest Algorithm 5 can be replaced by any algorithm that encodes electronic files into digital values. The first processing unit 102 compresses the encrypted original package, the check sum and a version number of the original package (i.e. Android version 4.3), and obtains the corresponding publication package. The communication unit 101 transmits, through the Internet, the publication package to the mobile device 110. After the mobile device 110 receives the publication package through the receiving unit 111, the second processing unit 112 checks the configuration of the mobile device 110.

In this embodiment, the items of the above configuration checks of the mobile device 110 include storage capacity, power capacity of the battery and device status (charging status) of the mobile device 110. The purpose of performing the configuration checks is to predict the occurrence of an unexpected condition leading to update failure in the mobile device 110. First, the second processing unit 112 checks whether the storage capacity of the memory unit 113 is large enough to load the publication package or not. The memory unit 113 can be a memory cache in the mobile device 110. Then the second processing unit 112 checks whether the power capacity of the battery of the mobile device 110 is greater than a first power capacity or not, wherein the first power capacity is the power capacity needed for performing a software update. For example, the second processing unit 112 checks whether the power capacity of the battery of the mobile device 110 is greater than 10% or not. Finally, the second processing unit 112 checks the device status of the mobile device 110. For example, the mobile device 110 cannot pass the configuration checks if the mobile device 110 is being charged. The device status of the mobile device 110 includes whether the mobile device 110 is running an important application or not. For example, the user is communicating with people or using a driving navigation app through the mobile device 110. It is notable that the above configuration checks of the mobile device 110 can be performed by a program (i.e. an app of a smartphone). If every configuration of the mobile device 110 meets the requirements, the second processing unit 112 decompresses the publication package to obtain the encrypted original package, the check sum and the version number of the original package; otherwise the second processing unit 112 indicates that the software update has failed.

The second processing unit 112 checks whether the check sum and the version number of the original package are correct or not. If the check sum and the version number of the original package are correct, the second processing unit 112 restarts the mobile device 110 to enter the recovery mode; otherwise the second processing unit 112 indicates that the software update has failed. After the mobile device 110 enters into the recovery mode, the second processing unit 112 decrypts, through the first key, the encrypted original package to obtain the original package. Then the second processing unit 112 uses the original package to update the Android operating system loaded in the mobile device 110.

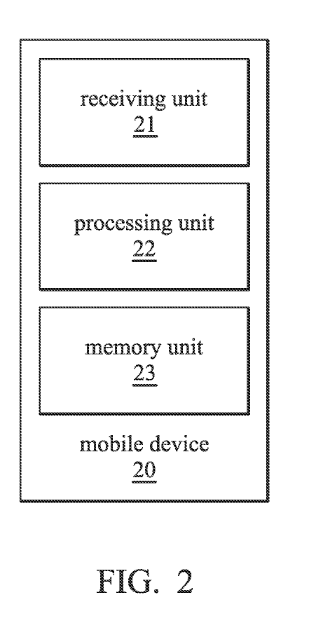

FIG. 2 is a block diagram of a mobile device 20 according to an embodiment of the present invention. As shown in FIG. 2, the mobile device 20 includes a receiving unit 21, a processing unit 22 and a memory unit 23. In this case the mobile device 20 is a smartphone which is equipped with the Android operation system, but the present invention is not limited thereto. The receiving unit 21 receives a compressed publication package from a service server. In this case, the publication package is, like the software package for updating Android version 4.3, used to update the Android operating system loaded in the mobile device 20, but the present invention is not limited thereto.

The processing unit 22 checks whether the configuration of the mobile device 20 meets the requirements or not. First, the processing unit 22 checks whether the storage capacity of the memory unit 23 is large enough to load the publication package or not. In this case, the memory unit 23 can be a memory cache in the mobile device 20. Then the processing unit 22 checks whether the power capacity of the battery of the mobile device 20 is greater than a first power capacity or not, wherein the first power capacity is the power capacity needed for performing software update. The processing unit 22 checks the device status of the mobile device 20. For example, the mobile device 20 cannot pass the configuration checks if the mobile device 20 is being charged. If every configuration of the mobile device 20 meets the requirements, the processing unit 22 decompresses the publication package; otherwise the processing unit 22 informs that the software update is fail. After the processing unit 22 decompresses the publication package, the processing unit 22 restarts the mobile device 20 to enter the recovery mode. After the mobile device 20 enters into the recovery mode, the processing unit 22 decrypts the encrypted publication package to obtain an original package. Then the processing unit 22 uses the original package to update the Android operating system loaded in the mobile device 20.

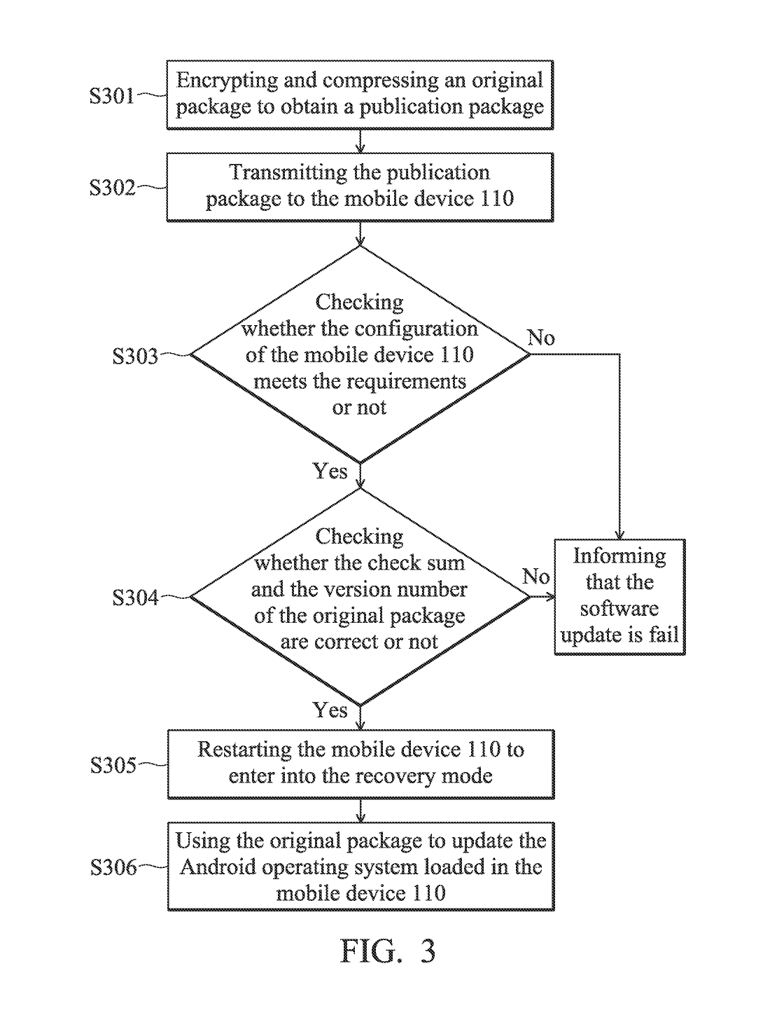

FIG. 3 shows a flow diagram to illustrate a software update method according to an embodiment of the present invention. The software update method illustrated in FIG. 3 is used to update the system software of the mobile device 110. In step S301, the server 100 encrypts and compresses an original package to obtain a publication package, and the method proceeds to step S302. In step S302, the server 100 transmits the publication package to the mobile device 110 according to the download request received from the mobile device 110 through the Internet, and the method proceeds to step S303. In step S303, the second processing unit 112 checks whether the configuration of the mobile device 110 meets the requirements or not. If every configuration of the mobile device 110 meets the requirements, the second processing unit 112 decompresses the publication package to obtain the encrypted original package, the check sum and the version number of the original package, and the method proceeds to step S304; otherwise the second processing unit 112 informs that the software update is fail.

In step S304, the second processing unit 112 checks whether the check sum and the version number of the original package are correct or not. If the check sum and the version number of the original package are correct, the method proceeds to step S305; otherwise the second processing unit 112 informs that the software update is fail. In step S305, the second processing unit 112 restarts the mobile device 110 to enter the recovery mode, the method proceeds to step S306. In step S306, the second processing unit 112 decrypts, through the first key, the encrypted original package to obtain the original package, and then the second processing unit 112 uses the original package to update the Android operating system loaded in the mobile device 110.

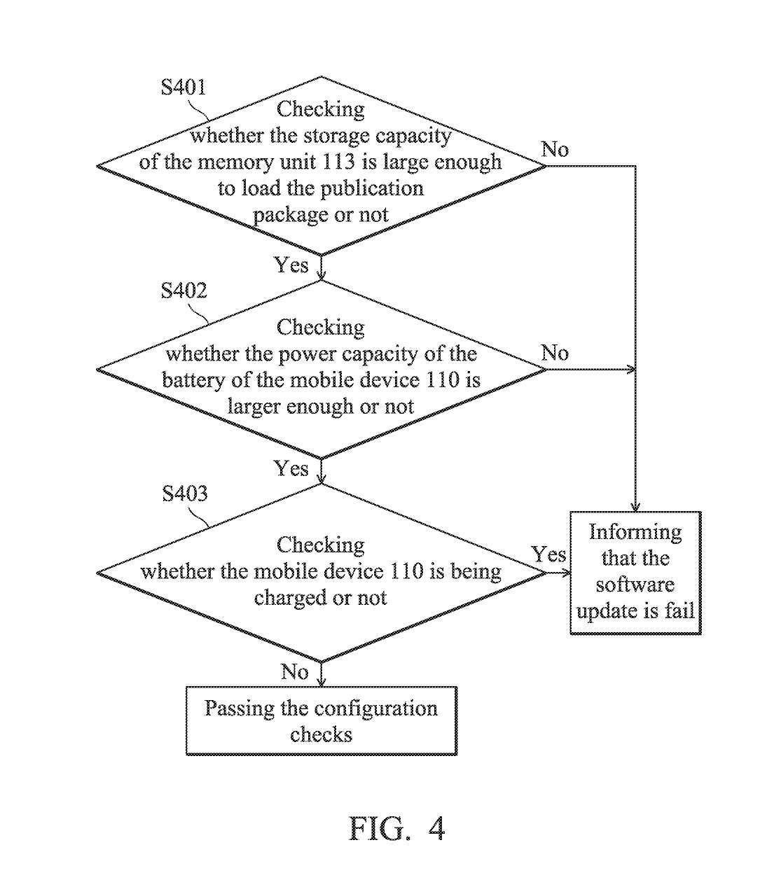

FIG. 4 shows a flow diagram to illustrate the procedure by which the second processing unit 112 checks the configuration of a mobile device according to an embodiment of the present invention. In step S401, the second processing unit 112 checks whether the storage capacity of the memory unit 113 is large enough to load the publication package or not. If the storage capacity of the memory unit 113 is large enough, the method proceeds to step S402; otherwise the second processing unit 112 informs that the software update is fail. In step S402, the second processing unit 112 checks whether the power capacity of the battery of the mobile device 110 is greater than a first power capacity or not, wherein the first power capacity is the power capacity needed for performing software update. If the power capacity is large enough, the method proceeds to step S403; otherwise the second processing unit 112 informs that the software update is fail. In step S403, the second processing unit 112 checks whether the mobile device 110 is being charged or not. The mobile device 110 passes the configuration checks if the mobile device 110 is not being charged; otherwise the second processing unit 112 informs that the software update is fail. Therefore the mobile device 110 can predict the occurrence of update failure according to the download checking mechanism of the present embodiment. Then the mobile device 110 can preclude the occurrence of the unexpected condition leading to update failure in the mobile device 110.

While the present invention has been described by way of example and in terms of preferred embodiment, it is to be understood that the present invention is not limited thereto. On the contrary, it is intended to cover various modifications and similar arrangements (as would be apparent to a person skilled in the art). Therefore, the scope of the appended claims should be accorded the broadest interpretation so as to encompass all such modifications and similar arrangements.

1. A software update method, comprising:
encrypting and compressing an original package to obtain a publication package;
transmitting the publication package from a service server to a mobile device according to a download request from the mobile device;
checking whether the configuration of the mobile device meets requirements or not;
decompressing the publication package if the configuration of the mobile device meets the requirements;
preparing a first key to encrypt the original package;
calculating a check sum according to the encrypted original package; and
compressing the encrypted original package, the check sum and a version number of the original package into the publication package, wherein after decompressing the publication package to obtain the encrypted original package, the check sum and the version number of the original package, the method further comprises:
checking whether the check sum and the version number of the original package are correct or not; and
restarting the mobile device for a software update if the check sum and the version number of the original package are correct.

2-3. (canceled)

4. The software update method of claim 1, wherein after restarting the mobile device, the method further comprises:
decrypting, according to the first key, the encrypted original package to obtain the original package; and
updating an operating system of the mobile device according to the original package.

5. The software update method of claim 1, wherein checking whether the configuration of the mobile device meets the requirements or not further comprises:
checking whether the power capacity of the mobile device is greater than a first power capacity or not; and
checking whether the mobile device is being charged or not.

6. The software update method of claim 5, wherein checking whether the configuration of the mobile device meets the requirements or not further comprises:
checking whether the capacity of a memory unit of the mobile device is larger than the capacity of the publication package or not.

7. A software update system, comprising a service server and a mobile device, wherein the service server comprises a first processor and a first memory, the first processor reads and executes a set of first instructions stored in the first memory, and therefore the first processor works as comprising:
a first processing unit encrypting and compressing an original package to obtain a publication package, wherein the first processing unit preparing a first key to encrypt the original package;
wherein the first processing unit calculating a check sum according to the encrypted original package; and;
wherein the first processing unit compressing the encrypted original package, the check sum and a version number of the original package into the publication package; and
a communication unit transmitting the publication package from the service server to the mobile device according to a download request from the mobile device,
wherein the mobile device comprising a second processor and a second memory, the second processor reads and executes a set of second instructions stored in the second memory, and therefore the second processor works as comprising:
a receiving unit receiving the publication package; and
a second processing unit checking whether the configuration of the mobile device meets the requirements or not and decompressing the publication package if the configuration of the mobile device meets the requirements, wherein the second processing unit decompresses the publication package to obtain the encrypted original package, the check sum and the version number of the original package;
wherein the second processing unit checks whether the check sum and the version number of the original package are correct or not; and
wherein the second processing unit restarts the mobile device for a software update if the check sum and the version number of the original package are correct.

8-9. (canceled)

10. The software update system of claim 7, wherein
after restarting the mobile device, the second processing unit decrypts, according to the first key, the encrypted original package to obtain the original package; and
the second processing unit updates an operating system of the mobile device according to the original package.

11. The software update system of claim 7, wherein the second processing unit checks whether the configuration of the mobile device meets the requirements or not, further comprising:
checking whether the power capacity of the mobile device is greater than a first power capacity or not; and
checking whether the mobile device is being charged or not.

12. The software update system of claim 11, wherein the second processing unit checks whether the configuration of the mobile device meets the requirements or not, further comprising:
checking whether the capacity of a memory unit of the mobile device is larger than the capacity of the publication package or not.

13. A mobile device, comprising a processor and a memory, wherein the processor reads and executes a set of instructions stored in the memory, and therefore the processor works as comprising:
a receiving unit receiving, from a service server, a publication package which has been encrypted and compressed; and
a processing unit checking whether the configuration of the mobile device meets requirements or not and decompressing the publication package if the configuration checks of the mobile device meet the requirements, wherein after the processing unit decompresses the publication package into an original package, the processing unit checks whether a version number of the original package are correct or not.

14. The mobile device of claim 13, wherein the processing unit checking whether the configuration of the mobile device meets the requirements or not further comprises:
checking whether the power capacity of the mobile device is greater than a first power capacity or not; and
checking whether the mobile device is being charging or not.

15. The mobile device of claim 13, wherein the processing unit checks whether the configuration of the mobile device meets the requirements or not, further comprising:
checking whether the capacity of a memory unit of the mobile device is larger than the capacity of the publication package or not.
